(19) United States
(12) Patent Application Publication
(10) Pub. No.: US 2025/0169466 A1
(43) Pub. Date: May 29, 2025

(54) Animal Caging System with Complete Line of Sight

(71) Applicant: Allentown, LLC, Allentown, NJ (US)

(72) Inventor: Steve Miller, Cream Ridge, NJ (US)

(21) Appl. No.: 18/962,493

(22) Filed: Nov. 27, 2024

Related U.S. Application Data
(60) Provisional application No. 63/603,550, filed on Nov. 28, 2023.

(51) Int. Cl. A01K 1/03; A01K 1/035

(52) U.S. Cl. CPC A01K 1/031; A01K 1/0356

(57) ABSTRACT

An animal caging system with complete line of sight that allows for unobstructive view of the occupant animals from the top of the cage to any location within. Optionally, the animal caging system includes a feeder or feeder and watering tray system that baffles supply air from a top of the cage to a bottom of the cage.

### BACKGROUND OF THE INVENTION

### Field of the Invention

The present invention relates in general to an animal caging system and, in particular, to animal caging system including a complete line of sight within the cage.

### Description of Related Art

Animal cages and animal caging systems are known. U.S. Pat. No. 6,308,660 describes an animal caging system including a self-sealing or filtered opening animal cage removably connected to an air supply and an exhaust. The self-sealing or filtered opening animal cage is supported by a rack. The self-sealing or filtered opening animal cage is sealed by an air inlet connection and an air outlet connection to the air supply and the exhaust connection. After the cages are removed from the air supply and the exhaust, the air inlet connection and the exhaust connection seals the cage or has a filter media applied to the cage and top to prevent air from entering or exiting the cage.

In the realm of laboratory animal science, it is desirable to observe animals within the animal caging system for animal welfare. It is desirable to provide an improved animal caging system that allows for unobstructive view of the occupant animals from the top of the caging to any location within the cage.

### BRIEF SUMMARY OF THE INVENTION

The present invention relates to an animal caging system with complete line of sight that allows for unobstructive view of the occupant animals from the top of the cage to any location within. The animal caging system allows for minimizing the number of camera's required for remote vision and maximize observation for animal welfare.

In one embodiment the animal caging system includes a feeder or feeder and watering tray system that baffles supply air from a top of the cage to a bottom of the cage. The baffling decouples the supply from the exhaust airflow streams, preventing short circuiting of the airflow.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a schematic diagram of animal caging system with complete line of sight.

### DETAILED DESCRIPTION OF THE INVENTION

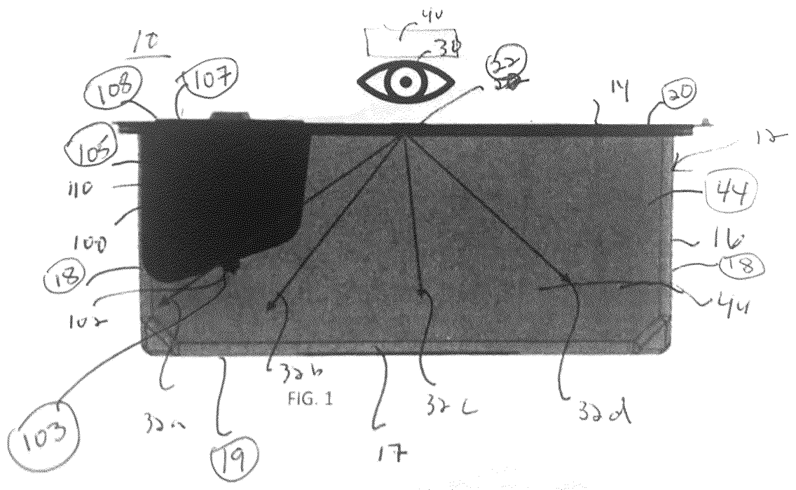

FIG. 1 is a schematic diagram of animal caging system with complete line of sight 10. Animal cage 12 comprises cage top 14 and cage bottom 16. Portion 20 in cage top 14 is transparent for providing a complete line of sight from observation area 30 along representative sight lines 32a-d. One or more cameras 40 can be positioned at observation area 30. One or more cameras 40 can observe interior 44 of animal cage 12. One or more cameras 40 can observe the entire floor 17 of cage bottom 16. Cage bottom 16 comprises end walls 18 integral with side walls 19. Cage top comprises walls 21 integral with ceiling 22.

Cage top 14 and bottom 16 can be constructed of a polymer. Suitable polymer materials include, but not limited to polyethylene terephthalate. Any or all end walls 18, side walls 19 and floor 17 of cage bottom 16 can have a material thickness between about 0.005 inches to about 0.125 inches. Any or all walls 20 and ceiling 21 of cage top 14 can have a material thickness between about 0.005 inches to about 0.125 inches.

Animal caging system can include a feeder 100. Feeder 100 can be positioned adjacent to one of end walls 18. Feeder 100 is positioned to be outside of the complete line of sight along representative sight lines 32a-32d and not obstruct sight lines 32a-32d. Feeder 100 can include water tray system 102. Nozzle 103 can be positioned at bottom 105 of water tray system 102. Water tray system 102 can disperse water through nozzle 103 to interior 44 of animal cage 12. Feeder 100 can include housing 105. Housing 105 can receive animal food. Feeder 100 can include opening 107 at top portion 108. Opening 107 can be covered by filter 109. Top portion 108 of feeder 100 is adjacent or integral with top 14. One or more baffles 110 are positioned within feeder 100. Baffles 110 baffle supply air through feeder 100 from portion 108 of feeder 100 to bottom 16 of animal cage 12.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A animal caging system comprising:
an animal cage comprising a cage top and a cage bottom, and
a portion of the cage top is transparent, wherein a complete line of sight is present from an observation area above the cage along one or more sight lines to the bottom of the cage.

2. The animal caging system according to claim 1 further comprising one or more cameras positioned in the observation area, and the bottom of the cage including a floor, wherein the one or more cameras observe an entire portion of the floor of cage the bottom and an interior of the cage.

3. The animal caging system according to claim 1 further comprising a feeder positioned adjacent to an end wall of the animal cage, the feeder being positioned outside of the one or more sight lines.

4. The animal caging system according to claim 4 wherein the feeder includes a water tray system.

5. The animal caging system according to claim 5 wherein the water tray system includes a nozzle.

6. The animal caging system according to claim 4 wherein said feeder includes one or more baffles positioned within said feeder, wherein the one or more baffles baffle supply air through the feeder from a top portion of the feeder to a bottom of the animal cage.

7. The animal caging system according to claim 1, wherein said cage top including one or more walls extending from a ceiling and said cage bottom including one or more walls extending from a floor and wherein at least one of the walls extending from the ceiling and/or the at least one of the wall extending from the floor have a material thickness between about 0.005 to about 0.125 inches.

8. An animal caging system comprising:
an animal cage comprising a cage top and a cage bottom, and
a portion of the cage top is transparent, wherein a complete line of sight is present from an observation area above the cage along one or more sight lines to the bottom of the cage;
one or more cameras positioned in the observation area, and the bottom of the cage including a floor, wherein the one or more cameras observe an entire portion of the floor of cage the bottom and an interior of the cage. The animal caging system according to claim 1 further comprising a feeder positioned adjacent to an end wall of the animal cage, the feeder being positioned outside of the one or more sight lines.

9. The animal caging system according to claim 8 wherein the feeder includes a water tray system.

10. The animal caging system according to claim 9 wherein the water tray system includes a nozzle.

11. The animal caging system according to claim 9 wherein said feeder includes one or more baffles positioned within said feeder, wherein the one or more baffles baffle supply air through the feeder from a top portion of the feeder to a bottom of the animal cage.

12. The animal caging system according to claim 8, wherein said cage top including one or more walls extending from a ceiling and said cage bottom including one or more walls extending from a floor and wherein at least one of the walls extending from the ceiling and/or the at least one of the wall extending from the floor have a material thickness between about 0.005 to about 0.125 inches.
